(19) United States
(12) Patent Application Publication
(10) Pub. No.: US 2020/0065353 A1
(43) Pub. Date: Feb. 27, 2020

(54) DATA VALIDATION AND HEALING THROUGH GROUP ASSOCIATION

(71) Applicant: Zest Labs, Inc., San Jose, CA (US)

(72) Inventors: Peter A. Mehring, Los Altos, CA (US); Thomas Reese, Ellicott City, MD (US); Scott A. Durgin, San Jose, CA (US)

(21) Appl. No.: 16/548,702

(22) Filed: Aug. 22, 2019

Related U.S. Application Data
(60) Provisional application No. 62/721,514, filed on Aug. 22, 2018.

(51) Int. Cl. G06F 17/18; G06F 11/07; H04L 29/08; G06K 19/07

(52) U.S. Cl. CPC G06F 17/18; G06F 11/0709; G06K 19/0723; G06F 11/0793; H04L 67/1095

(57) ABSTRACT

A computer-implemented method, according to one embodiment, includes receiving one or more monitored conditions associated with objects; creating ad hoc groupings for the objects, wherein each ad hoc grouping is based on at least one of the conditions; receiving at least one data point associated with each object; selecting an ad hoc grouping for validation; and determining whether the data points are valid using the data points associated with the objects in the selected ad hoc grouping.

### FIELD OF THE INVENTION

The present invention relates to monitoring conditions and data collection, and more particularly, this invention relates to data validation and healing through group association.

### BACKGROUND

Devices may be used to collect data for a variety of purposes, such as monitoring conditions of a specific object, monitoring conditions of a process, monitoring the conditions of a group of objects or processes, etc. There is no redundancy in data collection when using a device to monitor a single object or process. There is redundancy in data collection when two devices are used to collect the same data. The data associated with each device may be used to validate the data collected by the data associated with any other device. In some fault tolerant systems, a plurality of devices may be used to collect data for a single purpose. The collected data is compared to determine whether the data is consistent for a majority of devices. Conventional fault tolerance techniques may be used to validate device data collection for the conditions of objects and processes.

### SUMMARY

A computer-implemented method, according to one embodiment, includes receiving one or more monitored conditions associated with objects; creating ad hoc groupings for the objects, wherein each ad hoc grouping is based on at least one of the conditions; receiving at least one data point associated with each object; selecting an ad hoc grouping for validation; and determining whether the data points are valid using the data points associated with the objects in the selected ad hoc grouping.

A computer-implemented method, according to another embodiment, includes determining ad hoc groupings for objects, wherein each ad hoc grouping is based on at least one condition of the objects; receiving data points associated with the objects; determining whether one or more of the data points associated with the objects in one of the ad hoc groupings is an outlier from other data points associated with the objects in the ad hoc grouping; in response to determining that one or more of the data points is an outlier, discarding the one or more outlier data points; and replacing the one or more outlier data points with a replacement data point determined based on the other data points associated with the objects in the ad hoc grouping.

A computer program, according to another embodiment, includes a nontransitory computer readable storage medium having program instructions embodied therewith, the program instructions executable by a computer to cause the computer to perform either or both of the foregoing methods.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a network architecture, in accordance with one embodiment.

FIG. 2 is a representative hardware environment, in accordance with one embodiment.

FIG. 3 is a system diagram of a sensor network, according to one embodiment.

FIG. 4 is a system diagram for an integrated circuit (IC) chip for implementation in a radio-frequency identification (RFID) device, according to one embodiment.

FIG. 5 is a flowchart of a method, in accordance with one embodiment.

FIG. 6 is a flowchart of a method, in accordance with one embodiment.

### DETAILED DESCRIPTION

The following description is made for the purpose of illustrating the general principles of the present invention and is not meant to limit the inventive concepts claimed herein. Further, particular features described herein may be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of data validation and healing through group association and/or related systems and methods.

In one general embodiment, a computer-implemented method includes receiving one or more monitored conditions associated with objects; creating ad hoc groupings for the objects, wherein each ad hoc grouping is based on at least one of the conditions; receiving at least one data point associated with each object; selecting an ad hoc grouping for validation; and determining whether the data points are valid using the data points associated with the objects in the selected ad hoc grouping.

In another general embodiment, a computer-implemented method includes determining ad hoc groupings for objects, wherein each ad hoc grouping is based on at least one condition of the objects; receiving data points associated with the objects; determining whether one or more of the data points associated with the objects in one of the ad hoc groupings is an outlier from other data points associated with the objects in the ad hoc grouping; in response to determining that one or more of the data points is an outlier, discarding the one or more outlier data points; and replacing the one or more outlier data points with a replacement data point determined based on the other data points associated with the objects in the ad hoc grouping.

In yet another general embodiment, a computer program includes a nontransitory computer readable storage medium having program instructions embodied therewith, the program instructions executable by a computer to cause the computer to perform either or both of the foregoing methods.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer-executable instructions residing on a storage medium such as a physical (e.g., non-transitory) computer-readable medium. In addition, although specific embodiments of the invention may employ object-oriented software programming concepts, the invention is not so limited and is easily adapted to employ other forms of directing the operation of a computer.

The invention may also be provided in the form of a computer program product comprising a computer readable storage or signal medium having computer code thereon, which may be executed by a computing device (e.g., a processor) and/or system. A computer readable storage medium may include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

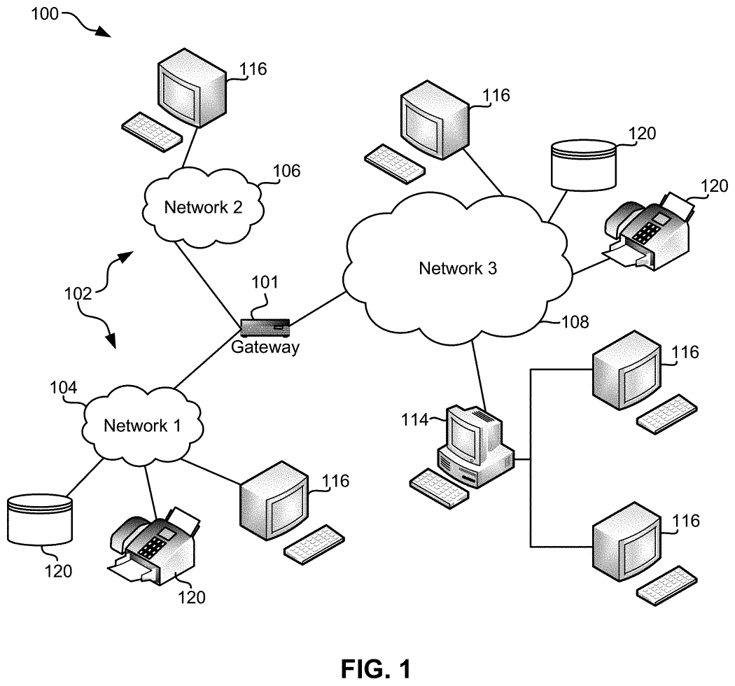

FIG. 1 illustrates an architecture 100, in accordance with one embodiment. As an option, the present architecture 100 may be implemented in conjunction with features from any other embodiment listed herein, such as those described with reference to the other FIGS. Of course, however, such architecture 100 and others presented herein may be used in various applications and/or in permutations which may or may not be specifically described in the illustrative embodiments listed herein. Further, the architecture 100 presented herein may be used in any desired environment.

As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, hand-held computer, printer or any other type of logic. It should be noted that a user device 116 may also be directly coupled to any of the networks, in one embodiment.

A peripheral 120 or series of peripherals 120, e.g. facsimile machines, printers, networked storage units, etc., may be coupled to one or more of the networks 104, 106, 108. It should be noted that databases, servers, and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used.

As an option, the present architecture 100 may be implemented in conjunction with features or systems from any other embodiment listed herein, such as those described with reference to the other FIGS. Of course, however, components of such architecture 100 and others presented herein may be used in various applications and/or in permutations which may or may not be specifically described in the illustrative embodiments listed herein. Further, various components of the architecture 100 presented herein may be used in any desired environment or system.

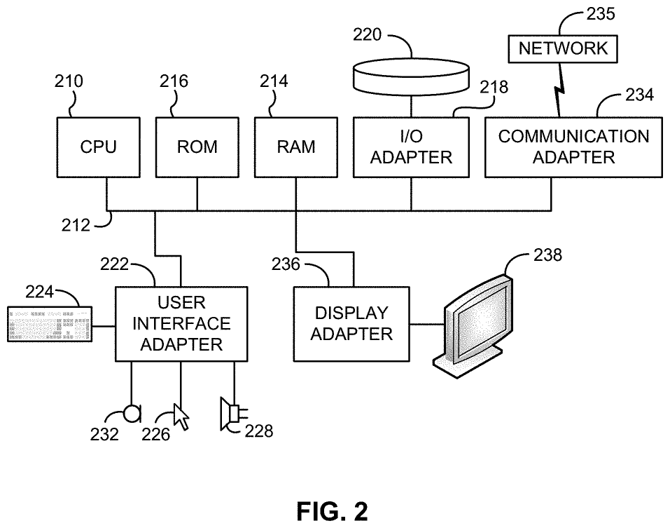

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft® WINDOWS® Operating System (OS), a macOS®, a Unix® OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Any of the embodiments described herein may incorporate a sensor network to continuously monitor the environment of handling of the goods at a unit level (e.g., individual product, carton, case, box, pallet, container, trailer, sea van, unit load device (ULD), etc.). According to one approach, a sensor network may include sensors of various protocols and standards, e.g., ZigBee®, low-power Bluetooth®, WiFi, global system for mobile communications (GSM) or cellular connectivity, satellite communications, etc., or other networks of sensors that have the ability to communicate with each other. Depending on the desired embodiment, the network of sensors may communicate with each other in a mesh topology, peer-to-peer, etc. As a result, wireless sensor networks have the desired benefit of allowing continuous access to any sensor of the network by accessing any other sensor.

In different embodiments, sensors of a sensor network may be distributed along the delivery supply chain (e.g., transit points, toll ways, ports, airports, weigh stations, truck stops, facility gates or entrances, storage facilities, processing facilities, etc.), or amongst the product being delivered. According to an example, a truck or container (e.g., trailer, sea van, ULD) full of cartons (goods) may be shipped with one sensor coupled to each of the cartons. Moreover, when the truck arrives at a checkpoint/location the sensor network may be accessed from, a fixed or mobile reader/access point outside the truck/trailer or container may read the sensors, or someone may open the back of the truck to read the sensors with a reader. In some scenarios, a signal may be too weak to reach each of the sensors in the whole truck (e.g., near the front of the truck). However, the wireless sensor network allows for the reader in the present example to access all of the sensors in the truck, including the ones that were not reached due to the strength of the signal. Here, the reader only needs to access at least one of the sensors to communicate with each of the sensors in the truck. Moreover, in some approaches, a mobile access point may be included in part, or all, of the shipment. The mobile access point will communicate with one or more sensor devices similar to the aforementioned access point/readers, which may then forward the sensor device data to a local or remote server or cloud-based processing system.

In some embodiments, condition data and/or handling data may be obtained from sensors of the sensor network that are distributed along the delivery supply chain and not coupled to the goods. In these embodiments, the condition data and/or handling data may provide information regarding environmental conditions. For example, in one embodiment, temperature and/or humidity data may be obtained from sensors that are not attached to any of the goods. In such an embodiment, the temperature and/or humidity data may include a temperature or humidity before or at the time of harvest of the goods being shipped. For some fruits and vegetables, the temperature or humidity before or at the time of harvest may be useful for calculating a shelf life or expiration date of the goods. In some embodiments, the condition data and/or handling data may be obtained from auxiliary sources, such as weather information networks, publicly-accessible data networks, etc.

According to one approach, the current condition of a shipment may be monitored by one or more RFID tags. Furthermore, the one or more RFID tags may communicate with an RFID reader and/or sensor network access point, either of which may be configured to perform at least one of the method steps illustrated in FIG. 1A.

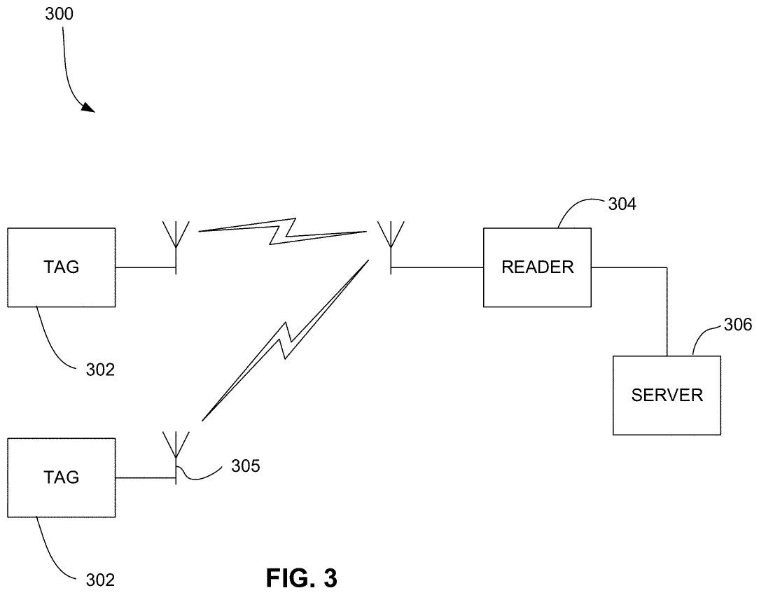

According to an embodiment, FIG. 3 depicts a sensor network 300, which may include some or all of the following components and/or other components. As an option, the sensor network 300 may be implemented in conjunction with features from any other embodiment listed herein, such as those described with reference to the other FIGS. Of course, however, the sensor network 300 and others presented herein may be used in various applications and/or in permutations which may or may not be specifically described in the illustrative embodiments listed herein. Further, the sensor network 300 presented herein may be used in any desired environment. Thus FIG. 3 (and the other FIGS.) should be deemed to include any and all possible permutations.

As shown in FIG. 3, one or more tags 302 are present. As used herein, each tag may comprise any label attached to a good for the purpose of identification, or to provide other information, or be a device located in close association and/or proximity to a unit quantity of goods. In some embodiments, the sensor network 300 may include a RFID system. In such embodiments, each of the tags 302 may comprise a RFID tag. Further, the RFID tags may include RFID and/or sensor network devices, e.g., depending on the desired embodiment. For example, each RFID tag may include a controller, a sensor and memory, which are preferably embodied on a single chip as described below, but may also or alternatively include a different type of controller, such as an application specific integrated circuit (ASIC), processor, an external memory module, etc. Of course, however, the one or more tags 302 may include Bluetooth®-enabled tags, ZigBee® tags, WiFi tags, cellular data tags, etc.

For purposes of the present discussion, the tags 302 will be described as including a chip. Each tag 302 may further include or be coupled to an antenna 305.

An illustrative chip is disclosed below, though actual implementations may vary depending on communication protocols and how the device is to be used. In general terms, a preferred chip includes one or more of a power supply circuit to extract and regulate power from a reader signal or a DC power source such as a battery or capacitor; a detector to decode signals from the reader; a backscatter modulator and/or transmitter to send data back to the reader; anti-collision protocol circuits; a sensor to monitor a specific condition; and at least enough memory to store its unique identification code, e.g., Electronic Product Code (EPC) and a sensor reading.

In some embodiments, each of the tags 302 may include a controller with on-board memory, a controller, and external memory, a controller with an on-board sensor, a controller and external sensor, etc.

Each of the tags 302 may be coupled to an object or item associated with a product being monitored, such as an article of manufacture, a container (e.g., box, carton, case, tote, cart, bin, pallet, ULD, sea van, etc.), a processing or storage location, a device, a person, etc. According to one approach, one or more of the tags 302 may be used to collect data pertaining to a present environmental, operational or freshness condition of the product being monitored. Therefore, any data reflecting the product's ongoing environmental condition and/or handling, along with a unique identification code (e.g., EPC), may then be transmitted to and stored by a cloud-based system, such as a cloud-based processing system, etc.

With continued reference to FIG. 3, a remote device 304 such as an access point, interrogator, or “reader” communicates with the tags 302 via an air interface, preferably using standard protocols. An “air interface” refers to any type of wireless communications mechanism. In one embodiment, wherein the tags 302 comprise RFID tags, the air interface may include the radio-frequency signal between the RFID tags and the remote device. One or more of the tags 302 may execute computer commands that the tag 302 receives from the remote device 304.

The sensor network 300 may also include an optional backend system such as a server 306, which may include databases containing information and/or instructions relating to the tags 302 and/or tagged items. In some approaches, server 306 may be a local or remote server, and may be logically connected either directly or over a network such as the Internet, a cellular network, a private wire line or wireless network, etc. In one embodiment, the server 306 may comprise one or more servers that are hosted in the cloud, which may also be referred to herein as cloud-based processing systems. Thus, although the server 306 is illustrated in FIG. 3 as being connected to the remote device 304 via a physical connection, in some embodiments the server 306 may be connected to the remote device 304 wirelessly.

Any data gathered and/or stored by the tags 302 or other sensor devices may be referred to as device data. Such data may be uploaded and stored on a cloud-based data storage and/or management system.

According to a preferred approach, the “data” may include sensor data collected by the tags 302, product data, traceability and waypoint data, supplier related data, shipping data, as well as other metadata. In a preferred approach, the tags 302 and other sensor network devices sensor may detect any number of environmental conditions and/or conditions of an object to which the sensor is attached or proximate to. According to various approaches, the sensor data may include, but is not limited to humidity, pH, temperature, sunlight, ultraviolet light, chemicals, radioactivity, pathogens, presence of bacteria, presence of viruses, presence of prions, gases (e.g., carbon dioxide level, oxygen level, ethylene level, nitrogen level, etc.), etc., or any other data which would be desired and/or apparent to one skilled in the art upon reading the present description.

According to an embodiment, the data may further include an association of the tags and a product to which the tags may be directly or indirectly coupled. Moreover, the data received from the tags may include unique product information regarding the product to which the tags may be directly or indirectly coupled, as will be discussed in further detail below.

In one approach, a remote device 304 may process some or all of the data collected by a tag 302. In another approach, some or all of the data collected by a tag 302 may be transmitted to a server 306 for processing. The processed data may then be delivered directly to a user e.g., via an email, a printed list, etc.; uploaded to a cloud-based data management system; sent to a remote device and/or computer application for processing and/or display; accessible to an owner e.g., as a summary, the raw data, a representational graph, etc.; etc. Thus, in one particular approach, a summary of the information pertinent to a particular owner may be provided thereto by accessing the cloud-based data management system.

According to various approaches, a summary of tag data may be compiled into a graph, a chart, a table, a list, etc. In one example, the summary of tag data may incorporate a table which may include one, some, or all of an event time, the last temperature, the last temperature log time, number of extreme high alarms, the number of extreme low alarms, the number of high alarms, the number of low alarms, the number of temperature logs, the number of way point logs, received signal strength indication (RSSI) state, etc.

According to yet another approach, the tag data may incorporate thresholds (e.g., high, low, specific values, etc.) according to any of the embodiments described herein. In one approach, portions of the tag data may be evaluated, thereby forming summaries e.g., quality factor, average, median, standard deviation, effective life of a product, etc. In varying approaches, data summaries may be compared to the aforementioned thresholds, stored on the cloud-based data storage system, output to an approved owner, etc.

Thus, as mentioned above, tags or sensor network devices and/or tag readers or network access points may be used in combination with the system illustrated in FIGS. 2A-2B. Moreover, a reader or network access point may be configured to perform at least one of the method steps shown in FIGS. 1A-1B. In yet further embodiments, any of the approaches described herein may be implemented within a business entity's operations to measure the business' own adherence to process standards, e.g., using as a metric to measure if an operation has met defined conditions and/or is completed.

With continued reference to FIG. 3, as noted above, each of the tags 302 may be associated with a unique identifier. Such identifier is preferably an EPC code, but may additionally or alternatively be a universal product code (UPC), a price look-up code (PLU), or a supplier name and batch or lot number. The EPC is a simple, compact identifier that uniquely identifies objects (e.g., items, cases, pallets, locations, etc.) in the supply chain. The EPC is built around a basic hierarchical idea that can be used to express a wide variety of different, existing numbering systems, like the EAN.UCC System Keys, unique identifier (UID), vehicle identification number (VIN), and other numbering systems. Like many current numbering schemes used in commerce, the EPC is divided into numbers that identify the manufacturer and product type. In addition, the EPC uses an extra set of digits, a serial number, to identify unique items. A typical EPC number contains:
1. Header, which identifies the length, type, structure, version and generation of EPC;
2. Manager Number, which identifies the company or company entity;
3. Object Class, similar to a stock keeping unit (SKU); and
4. Serial Number, which is the specific instance of the Object Class being tagged.
   Additional fields may also be used as part of the EPC in order to properly encode and decode information from different numbering systems into their native (e.g., human-readable) forms.

Each tag 302 may also store information about the item to which coupled, including but not limited to a name or type of item, serial number of the item, date of manufacture, place of manufacture, owner identification, origin and/or destination information, expiration date, composition, information relating to or assigned by governmental agencies and regulations, etc. Furthermore, data relating to an item can be stored in one or more databases linked to the tag. These databases do not reside on the tag, but rather are linked to the tag through a unique identifier(s) or reference key(s).

As noted above, in some embodiments the tags 302 may include one or more RFID tags. For such embodiments, Auto ID Center EPC-Compliant tag classes are set forth below:

### Class-1

Identity tags (RF user programmable, range ˜3 m)
Lowest cost

### Class-2

Memory tags (20 bit address space programmable at ˜3 m range)
Security & privacy protection
Low cost

### Class-3

Semi-passive tags (also called semi-active tags and battery assisted passive (BAP) tags)
Battery tags (e.g., 256 bits to 2M words)
Self-Powered Backscatter (internal clock, sensor interface support)
˜100 meter range
Moderate cost

### Class-4

Active tags
Active transmission (permits tag-speaks-first operating modes)
˜300 to ˜1,000 meter range
Higher cost

In RFID systems where passive receivers (e.g., Class-1 and Class-2 tags) are able to capture enough energy from the transmitted RF to power the device, no batteries are necessary. In systems where distance prevents powering a device in this manner, an alternative power source must be used. For these “alternate” systems (e.g., semi-active, semi-passive or battery-assisted), batteries are the most common form of power. This greatly increases read range, and the reliability of tag reads, because the tag does not need power from the reader to respond. Class-3 tags only need a 5 mV signal from the reader in comparison to the 500 mV that Class-1 and Class-2 tags typically need to operate. This 100:1 reduction in power requirement along with the reader's ability to sense a very small backscattered signal permits Class-3 tags to operate out to a free space distance of 100 meters or more compared with a Class-1 range of only about 3 meters. Note that semi-passive and active tags with built in passive mode may also operate in passive mode, using only energy captured from an incoming RF signal to operate and respond, at a shorter distance up to 3 meters.

Active, semi-passive and passive RFID tags may operate within various regions of the radio frequency spectrum. Low-frequency (e.g., 30 KHz to 500 KHz) tags have low system costs and are limited to short reading ranges. Low frequency tags may be used in security access and animal identification applications for example. Ultra-high-frequency (e.g., 860 MHz to 960 MHz and 2.4 GHz to 2.5 GHz) tags offer increased read ranges and high reading speeds.

A basic RFID communication between an RFID device and a remote device typically begins with the remote device, e.g., reader, sending out signals via radio wave to find a particular RFID device, e.g., tag via singulation or any other method known in the art. The radio wave hits the RFID device, and the RFID device recognizes the remote device's signal and may respond thereto. Such response may include exiting a hibernation state, sending a reply, storing data, etc.

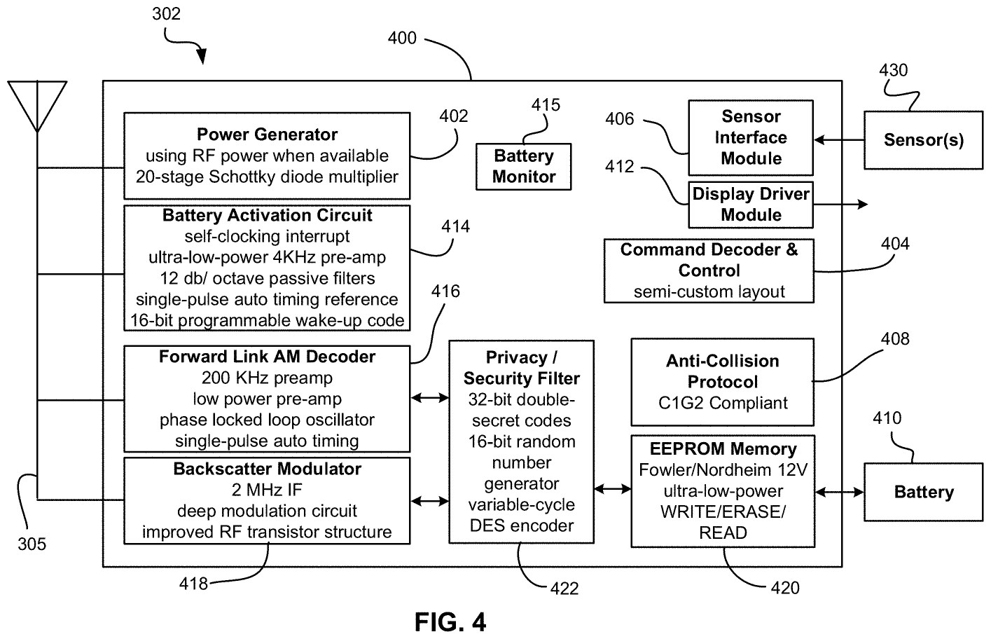

Embodiments including an RFID device are preferably implemented in conjunction with a Class-3 or higher Class IC chip, which typically contains the processing and control circuitry for most if not all tag operations, and a sensor 430. FIG. 4 depicts a conceptual circuit layout of a Class-3 IC 400 and the various control circuitry according to an illustrative embodiment for implementation in an RFID device implemented as a tag 302 (e.g., an RFID tag). It should be noted that the methods and systems disclosed herein may be implemented using any type of RFID device, and the circuit 400 is presented as only one possible implementation.

The Class-3 IC of FIG. 4 can form the core of RFID chips appropriate for many applications such as identification of pallets, cartons, containers, vehicles, or anything where a range of more than 2-3 meters is desired. As shown, the circuit 400 includes several circuits including a power generation and regulation circuit 402, a digital command decoder and control circuit 404, a sensor interface module 406, a C1G2 interface protocol circuit 408, a battery activation circuit 414, a battery monitor 415, one or more sensors 430, and a power source (e.g., a battery) 410. A display driver module 412 can be added to drive a display.

The RFID device may have a dedicated power supply, e.g., a battery; may draw power from a power source of the electronic device (e.g., battery, AC adapter, etc.); or both. Further, the RFID device may include a supplemental power source. Note that while the present description refers to a “supplemental” power source, the supplemental power source may indeed be the sole device that captures energy from outside the tag, be it from solar, RF, kinetic, etc., energy.

A forward link AM decoder 416 uses a simplified phase-lock-loop oscillator that requires only a small amount of chip area. Preferably, the circuit 416 requires only a minimum string of reference pulses.

A backscatter modulator block 418 preferably increases the backscatter modulation depth to more than 50%.

A memory cell, e.g., EEPROM, is also present, and preferably has a capacity from several kilobytes to one megabyte or more. In one embodiment, a pure, Fowler-Nordheim direct-tunneling-through-oxide mechanism 420 is present to reduce both the WRITE and ERASE currents to about 2 μA/cell in the EEPROM memory array. Unlike any RFID tags built to date, this permits reliable tag operation at maximum range even when WRITE and ERASE operations are being performed. In other embodiments, the WRITE and ERASE currents may be higher or lower, depending on the type of memory used and its requirements.

The circuit 400 may also incorporate a security encryption circuit 422 for operating under one or more security schemes, secret handshakes with readers, etc.

According to various embodiments, RFID tags may not communicate properly and/or efficiently in certain conditions and/or locations. In one example, an RFID tag may be intended to monitor one or more conditions such as temperature within a metal shipping container that may contain a perishable product being delivered to a Receiver as described above. However, the shipping container's metal structure may inhibit the RFID tag from communicating, e.g., receiving instructions, transmitting data, relaying an error, etc., with an RFID tag reader. Placing the RFID tag on the exterior of the container may remedy the communication problems, but then the RFID tag has no access to the conditions in the interior of the container.

To remedy the foregoing, an RFID tag may have an interface adapted to communicate with a sensor which is external and/or coupleable to the RFID tag, thereby allowing an RFID tag to maintain communication with an RFID tag reader while gathering readings in conditions and/or locations that otherwise could be problematic for RF communications.

In any of the embodiments, techniques and/or hardware known in the art may be used to implement the various operations.

Conventional fault tolerance techniques enable validation of device data collection for a plurality of objects and/or processes. In the emerging field of machine-to-machine communication (M2M) and the Internet of Things (IoT), data collected from devices may directly determine an action by a separate device, computer, equipment, etc. Sensors may be used to capture data from the field and any device. The sensors may be low cost. A concern with using low-cost sensors is that the sensors may be unreliable, either alone or as a result of incorrect installation. These sensors may also be susceptible to hacking both physically and electronically. Multiple sensors allow for validating the data from each sensor and increase the reliability of the readings from the sensors. Sensors may detect types of conditions such as the time, location, temperature, humidity, motion, installation/deinstallation status, etc.

Methods for validating and/or healing data as disclosed herein are used to maintain a consistently operating system wherein missing and/or invalid data does not cause operational mistakes, incomplete data records and/or delays in the system. In preferred embodiments, a number of data exceptions are minimized by constraining the type of corrections, limiting the variance from any expected and/or predetermined value, the number of frequency of corrections for a specific device and/or within a specific group, event, and/or time period, etc. In at least some embodiments, device data may be invalidated for some functions and corrected, completed, and/or maintained for other functions, e.g., managing the object associated with the device.

In preferred embodiments, data healing and/or data invalidation related to individual object functions associated with the device data (e.g., for individual objects and/or ad hoc groupings of objects), in addition to processing and/or trending evaluations, ensures the healed and/or invalidated data does not have unintended results for the overall system and the individual object may be managed through the system.

At least some embodiments presented herein provide ad hoc groupings for data collection devices. Each data collection device is associated with at least one object. The object may be perishable (e.g., limited shelf life) and/or consumable (e.g., limited useful operating life) product. The object may be any variety of perishable food product, fruit, produce, dairy, seafood, meat, freshly prepared foods, pharmaceuticals, electronics, consumer products, etc. In a preferred embodiment, the object may be a perishable food product. The data collection device may be any data collection device known in the art. In a preferred approach, the data collection device may include a sensor, e.g., as described above.

Various embodiments disclosed herein provide approaches for validating data from a device and monitoring the condition of a single object based on data from a device which is monitoring a substantially similar object. Both objects are considered to be within the same process and/or state. In at least some approaches, the objects may temporarily be considered to be within the same process and/or state.

For example, two or more objects may each have a device monitoring independent conditions for each object. The plurality of objects may be determined to be in the same environment for a predetermined amount of time. One having ordinary skill in the art upon reading the present disclosure would expect that the devices record and/or output the same or substantially similar conditions during this time. The devices (e.g., and any associated objects) may be considered to be in the same grouping for that amount of time based on the start time and end time for the grouping association. For the time period that the devices are members of the same group, the data may be compared to provide fault tolerance. In one approach, in response to a single device of the grouping missing a data collection point, the data collected from other members of the grouping during the same time may be used to fill in and/or replace the missing and/or invalid data collection point.

In at least some approaches, the fault tolerance capabilities provided by the ad hoc grouping as disclosed herein detect erroneous data collection due to a malfunctioning device, an improperly installed device, a condition forcing an erroneous condition, a manipulation of the device data, or any other condition or occurrence whereby data from a single device or a subset of device data varies from the grouping, as would be understood by one having ordinary skill in the art upon reading the present disclosure.

In preferred embodiments of the present invention, devices may be transient such that the devices may move from ad hoc grouping to other ad hoc groupings over time. In other preferred approaches, the devices may also be associated with more than one ad hoc grouping at a time. For example, in managing a production process for harvesting produce, if a data collection device is attached to each pallet of food as the food is harvested, the device may track with the pallet of food throughout processing. As each pallet of food is harvested in the field, and placed on a flatbed truck, the pallet of food becomes a member of the grouping of pallets on the truck, e.g., a harvest grouping. The harvest grouping may remain together until transported by the truck to a processing center, where the pallets are unloaded. When the pallets of food arrive at the processing center on the same truck, the pallets of food may be detected as a grouping as the pallets of food pass some waypoint such as the entry gate within the same time window. In one example, each pallet of food which passes through the waypoint within a three second time window may be considered part of the new grouping, e.g. a transport grouping. At this point, each pallet of food may be considered part of both the harvest grouping and the transport grouping. When the pallets of food are unloaded, the pallets of food may be further associated with the location as the pallets of food are unloaded, e.g., a location grouping. The pallets of food may be considered part of the harvest grouping, the transport grouping, and the location grouping at this point. The location grouping may include pallets of food which are already detected at that location. The pallets of food may be a member of both the location grouping and the harvest grouping from the truck as long as the pallets of food are kept together. As the pallets of food are further processed and change location, the location-based ad hoc groupings for the pallets of food may be adjusted according to sensor readings associated with location information, manual input, automated inputs (such as ones communicated to the sensor from a computer program), updated conditions, etc. For example, the pallets of food may leave the first location grouping and join a second location grouping as the pallets of food are sent to another location in a processing facility.

Various embodiments described herein validate different components of the data related to each group. For instance, the harvest grouping may validate the time and temperature at the field harvest. The location grouping may validate the temperature and location within the unloading and/or receiving zone. The data validation within the groupings provides further data fault tolerance. In a preferred embodiment, data points associated with objects within an ad hoc grouping may be validated comparing the data points to other data points of objects in the ad hoc grouping. For example, one would expect that sensors (e.g., devices) of multiple pallets of food which are processed at substantially the same time would output substantially the same temperature reading data point, humidity reading data point, timestamp, etc. Specifically, if one sensor reading outputs a temperature data point which is significantly above temperature data points for the other pallets of food within the ad hoc grouping (e.g., 80 degrees Fahrenheit (F) when the other data points are within a few degrees of 70 degrees F.), the sensor may be considered faulty and/or missing. The outlier data point may be discarded and/or invalidated as would be understood by one having ordinary skill in the art upon reading the present disclosure. In some approaches, a data point may be discarded in response to determining it value is outside a predefined factor of the standard deviation of the data points in the ad hoc grouping.

Data captured by devices may be validated and/or provide fault tolerance even if the devices are not in the same group. For example, in a harvesting process, there may be eight pallets of harvested food that are placed on a flatbed truck. The food items on the pallets may have been harvested in a sequence, and each pallet may have been subsequently placed on the truck about ten minutes apart. If information about one of the pallets failed to record when the pallet was put on the truck, an evaluation of the sequence of pallets being harvested may provide guidance as to a missing data element within the sequence. The fault tolerance may then determine the missing sequence element to heal the data for that device by completing the missing data element. This approach may be used where the data for a given device may be missing and/or does not adhere to the determined sequence for the grouping of devices. Various data healing techniques provided herein determine data fault tolerance for data elements that are not the same, but have a discernable and/or predictable pattern.

Data fault tolerance may be used for completing missing data points and/or determine inconsistent and/or invalid data for a device within a grouping as would be understood by one having ordinary skill in the art upon reading the present disclosure. In one example, data captured from various devices may be the basis for automated decision making and/or used in a complex fashion that may obscure the original data when presented to another system or user. Data may be healed and/or used to invalidate data when communicating alerts for data exceptions. Invalidating data when communicating alerts for data exceptions may reduce the number of alerts for data that was missing and/or invalid, thereby reducing nuisance alerts. Healed and/or validated data for trend analysis for each data component is valuable because each data component has an impact on the outcome of the trend analysis, and missing data components and/or invalid data components may skew the results. The data component may be marked to indicate that it was not a raw reading if the data was healed and/or invalidated previously.

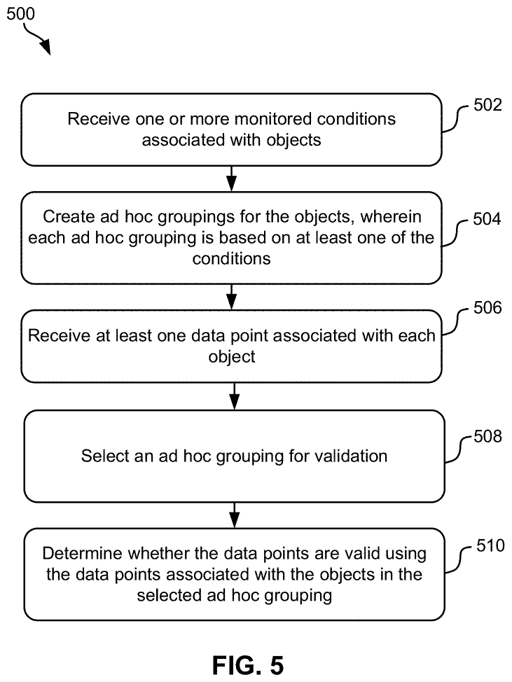

Now referring to FIG. 5, a flowchart of a method 500 is shown according to one embodiment. The method 500 may be performed in accordance with the present invention in any of the environments depicted in FIGS. 1-4 and 6, among others, in various embodiments. Of course, more or less operations than those specifically described in FIG. 5 may be included in method 500, as would be understood by one of ordinary skill in the art upon reading the present descriptions.

Each of the steps of the method 500 may be performed by any suitable component of the operating environment. For example, in various embodiments, the method 500 may be partially or entirely performed by sensors, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 includes operation 502. Operation 502 includes receiving one or more monitored conditions associated with objects. In a preferred embodiment, at least one monitored condition is received for each object in a plurality of objects. The monitored conditions may be received in any manner known in the art. In a preferred approach, the monitored condition is received from a device associated with an object. For example, for a plurality of objects, each object may be associated with a sensor which monitors the independent conditions associated with the corresponding object.

The devices used for monitoring conditions and/or collecting data (collectively, “information”) may be any type of device capable of monitoring conditions and/or collecting data. The devices may store the information thereon for later retrieval, and/or transmit the information wirelessly, etc. In some approaches, a device may be coupled to the object itself, a shipping container or pallet holding the object, etc. In other approaches, a device may be located at a known location, on a specific piece of equipment, etc. For example, a temperature monitoring device may be located in a cooling unit through which the objects pass. The readings taken for each of the objects may be processed as described herein to heal and/or validate/invalidate the data.

Conditions and/or data collected by the devices may include various attributes of the object, e.g., at various stages in the shipping process. Various attributes that may be collected may include one or more of: humidity, pH levels, temperature, firmness, sunlight, ultraviolet light, infrared light, atmospheric pressure, chemicals, radioactivity, pathogens, presence of bacteria, presence of viruses, presence of prions, carbon dioxide level, ethylene levels, etc., rates of change for any attribute, or any other data which may be desired and/or apparent to one skilled in the art upon reading the present description. In other embodiments, the various attributes may include any information about environmental characteristic that may affect the shelf life or expiration of the object being monitored.

Additional conditions and/or data collected by the devices may also include the following various attributes of the object, e.g., at various stages in the shipping process: product harvest temperature, harvest time, amount of precipitation in preceding 24 hours, outdoor temperatures in the preceding 24 hours, time until product is cooled to low temperature, low temperature product is cooled to, current product temperature, dwell time of product temperature at specific temperature ranges, estimated remaining shelf life at a specific point in time and/or at a specific process and/or transaction point, moisture content of product, Brix ratio of product or similar product from the same plant/bush/tree at a point in time, color reading, photo spectroscopy reading, hyperspectral reading, reflectivity reading, product weight, product dimensions, and/or other product measurements and/or conditions of the entire product or specific features of the product.

Data elements (e.g., data points) corresponding to the process parameters and/or shipping conditions may be received from and/or derived from a sensor on a wireless device/tag associated with the product and ideally coupled to said product during processing and/or shipment of the product. The wireless device may be any type of device capable of sending a sensor reading over a wireless link. For simplicity, much of the present description is described in terms of a sensor tag. This has been done by way of example only, and any type of wireless device, including those with integrated and/or external sensors may be used in various approaches and embodiments.

The coupling of the wireless device may be direct, e.g., a sensor device/tag is adhered to the product, inserted into the product (e.g., as a probe); or indirect, e.g., the sensor tag is coupled to a pallet, container, vehicle, etc. holding the product. For example, device/sensor reading may be taken by a sensor according to predefined criteria, e.g., periodically (at regular time interval), upon occurrence of some stimulus such as a change in custody, at specific process points, etc., or based on the current product location (e.g., process step as defined by equipment location, geofencing, etc.), or a change in one of the product parameters, etc. The tag may store the readings for later retrieval by a reader device or access point, which in turn may upload the readings to a server for generation of a transaction for the entity's or product's blockchain or other database. Preferably, the device/tag is authenticated using known authentication techniques, thereby ensuring the authenticity of the information so derived, and the data on the tag may be encrypted and secured, such that it is resistant to tampering when transferring the data to the transaction.

Attributes and/or parameters associated with the product may be gathered and/or derived from data elements utilizing a sensor network. According to one approach, sensor network devices (e.g., Radio Frequency Identification (RFID) sensors, Bluetooth® sensors, ZigBee, Wi-Fi sensors, cellular sensors, etc.) may be used to collect data pertaining to the condition of the product. Moreover, in other approaches, sensor network devices may be used to continuously collect environmental data pertaining to the product.

Operation 504 includes creating ad hoc groupings for the objects. In preferred embodiments, each ad hoc grouping is based on at least one of the conditions. For example, a location ad hoc grouping may be based on location conditions (e.g., GPS coordinates, cellular triangulation, WiFi locating tracking, RFID reader location, etc.), a harvest ad hoc grouping may be based on a timestamp associated with the harvest condition, a cooling ad hoc grouping may be based on a temperature reading which is indicative of a processing step for the object (e.g. forced cooling to a predetermined temperature for a group of products such as pre-cooling for produce), etc.

In preferred embodiments, each object may belong to at least one ad hoc grouping. Each object may belong to a plurality of ad hoc groupings at any given time.

For example, the groupings may be created based on occurrence of prespecified occasions where the occasions are indicative of conditions. A general example includes working with fresh food from the field or from the processing plant. The food leaves the field or the processing plant in batches (e.g., groupings). A truck is sent to pick up pallets with the food. The pallets on the truck may also become a batch. A sensor may be used per each pallet for economical and scientific reasons. A pallet of food typically has its own thermal mass which stays about constant although it may vary by a few degrees within the actual pallet. Group identity may be determined by any of a number of methods. Grouping by proximity may be the least complex method. The proximity may be determined from readings by the devices, such as GPS coordinates, by sharing a common resource such as a wireless access point, etc. An example of grouping occurs when all of the pallets on a truck are grouped by time window. In one example, a truck carrying pallets of food drives through access points on the yard at 10 to 20 miles per hour (mph). All of the pallets detected within a two to five second time window may be placed in the same grouping coming from the same truck.

Ad hoc groupings may be determined more broadly or more narrowly based on the data validation procedures described herein. Ad hoc groupings may be determined based on historical information associated with determining data similarities and/or detectable sequences. Proximity may also span different time periods as best serves the data validation process. For instance, devices may be grouped as the devices pass a specific waypoint in a very short maximum amount of time (e.g., based on the expected speed at which the devices pass the waypoint, possibly with some guard banding) and/or the devices may be grouped based on being in the same location for a minimum amount of time, such as at a receiving area at an off-loading point. Proximity may be further defined and/or qualified by a combination of criteria, such as being in one defined location communicating to a wireless access point, but combined with not communicating with neighboring wireless access points, thereby providing additional exclusivity for the grouping with a combination of criteria.

Operation 506 includes receiving at least one data point associated with each object. In various approaches, a data point may be any condition as described above and/or any value derived from a condition described above.

Operation 508 includes selecting an ad hoc grouping for validation. In various approaches, at least one ad hoc grouping is selected for validation. In a preferred approach, the selection is based on the condition and/or the data point. In other approaches, the selection is based on the location of the objects. For example, the data points may correspond to temperature readings for sensors associated with pallets of food at receiving, or a type of food. A “receiving” ad hoc grouping may be selected for validating temperature readings at the receiving location in the supply chain as would be understood by one having ordinary skill in the art upon reading the present disclosure. These selections may be further refined by considering known attributes of the products in conjunction with other grouping criteria, such as, for example, pallets of lettuce in the receiving area, which might be distinct from pallets of celery in the same area at the same time.

Operation 510 includes determining whether the data points are valid using the data points associated with objects in the selected ad hoc grouping. For example, a temperature reading for an object in a receiving ad hoc grouping may be compared to other temperature readings for other objects in the receiving ad hoc grouping. In a preferred embodiment, determining whether the data points are valid includes determining that the data points are within a predefined range of the other data points associated with the ad hoc groupings, an average value of the data points associated with the ad hoc grouping, etc. Any predefined range and/or value as disclosed herein may be found in a look-up table, experimentally determined, statistically determined, determinable according to any algorithm known in the art, etc.

In response to determining a data point is invalid, in preferred embodiments, the invalid data point may be discarded. In some approaches, a data point which is invalid is considered an outlier. In one approach, the discarded data point may be replaced with a replacement data point. The replacement data point may be calculated based on the average of the other data points associated with the ad hoc groupings in at least some approaches. The replacement data point may be calculated in any manner known in the art. In a preferred approach, the replacement data point is an average of the remaining data points associated with objects in the selected ad hoc grouping.

In another example, the replacement data point may also include (or reflect) a predetermined offset, e.g., from the calculated average, to the effect of being more conservative than the average, when interpreted for the product or process at that specific datapoint time and/or location.

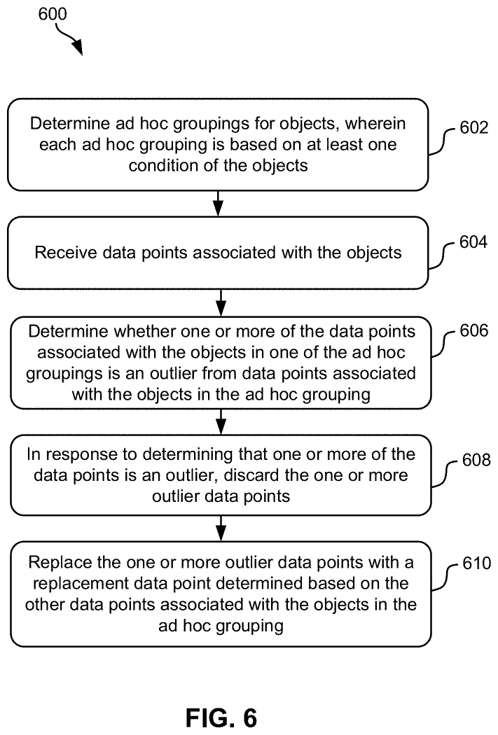

Now referring to FIG. 6, a flowchart of a method 600 is shown according to one embodiment. The method 600 may be performed in accordance with the present invention in any of the environments depicted in FIGS. 1-5, among others, in various embodiments. Of course, more or less operations than those specifically described in FIG. 6 may be included in method 600, as would be understood by one of ordinary skill in the art upon reading the present descriptions.

Each of the steps of the method 600 may be performed by any suitable component of the operating environment. For example, in various embodiments, the method 600 may be partially or entirely performed by sensors, or some other device having one or more processors therein. The processor, e.g., processing circuit(s), chip(s), and/or module(s) implemented in hardware and/or software, and preferably having at least one hardware component may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, method 600 includes operation 602. Operation 602 includes determining ad hoc groupings for the objects, where each ad hoc grouping is based on at least one of the conditions. In one approach, the ad hoc groupings may be determined according to any of the embodiments described above with reference to method 500 and/or otherwise described herein. In another approach, the ad hoc groupings may be determined from a pre-defined list of ad hoc groupings, received in any manner known in the art, etc.

Operation 604 includes receiving data points associated with at least some of the objects. In various approaches, a data point may be any condition as described above and/or any value derived from a condition described above.

Operation 606 includes determining whether one or more of the data points associated with the objects in one (or more) of the ad hoc groupings is an outlier from other data points associated with the data objects in the ad hoc grouping. In a preferred approach, operation 606 includes comparing data points associated with devices in an ad hoc grouping to determine whether a data point is an outlier in any manner known in the art.

In any embodiment described herein, an outlier may be determined by fitting data points to a polynomial and determining outliers by the deviation from the fit. Adherence of measured data to the fit data may be regarded as the “smoothness” of the polynomial fit when plotted. Deviation of the measured data from the polynomial fit (e.g., such as kinks and/or other variations from the relatively smoother portions) may be indicative of outliers. In various approaches, if the outliers are within a predefined range outside the fit, the data point may be considered invalid. A data point may be considered an outlier based on being outside a predefined distance from the average of the data points and/or an expected value. Outliers may be determined in any manner known in the art.

In addition, a data point that is missing data (and equivalently, a missing data point) is considered an outlier data point in some embodiments. For example, where a grouping includes 10 objects but data points for only 9 of the objects are received, the missing data point may be considered an outlier and healed as described below in relation to operation 610. A data point may be missing its data and/or a data point may be missing due to any plausible reason, such as a faulty sensor failing to collect data, a transmitter of the data being within a metal shipping container, a dead batter on such a transmitter, communication error, etc.

Operation 608 includes, in response to determining that one or more of the data points is an outlier, discarding the one or more outlier data points. In various embodiments, the outlier data point may be discarded in any manner known in the art. In some approaches, the outlier data point may be invalidated for at least some functions but maintained for other functions. For example, an outlier temperature data point may be invalidated for determining average values, calculating healing data points, etc. The outlier temperature data point may be maintained due to an associated timestamp for reference in managing the object.

In a further approach, discarding an outlier data point may be performed by replacing the outlier data point with some data, e.g., as in operation 610. Thus, for example, operations 608 and 610 may be performed using a single operation that overwrites the outlier data point with a replacement value. Such single operation or the like is intended to be encompassed by the process 600 disclosed herein.

Operation 610 includes replacing the one or more outlier data points with a replacement data point or points determined based on the other data points associated with the objects in the ad hoc grouping. In one approach, a replacement data point may be selected from a look-up table. In other approaches, determining the replacement data point includes calculating the replacement data point based on the data points associated with the objects in the ad hoc grouping (e.g., the non-discarded data points). A replacement data point may be calculated in any manner known in the art. In a preferred approach, the replacement data point is calculated based on an average of corresponding data points associated with objects in the ad hoc grouping. In another approach, a data point for another object in the ad hoc grouping may be used as the replacement data point.

In another approach, a missing data point (outlier data point) may be determined to be part of a sequence of data points from within the ad hoc group. Completing the sequence can be used to determine the replacement data point. For example, a timestamp for one of the objects may be missing, but the correct time may be inferred based on data points for other objects in the ad hoc grouping. Moreover, an offset may be applied to the replacement data point to reflect a more conservative interpretation of the data. For example, a predetermined time period may be added to the timestamp to ensure the estimated value for the replacement data point is more likely closer to accurate than not, and not an overly aggressive estimate.

In a preferred embodiment, an outlier data point may be replaced with a healing data point (e.g., a replacement data point selected to approximate a correct value for the outlier data point). In one approach, the healing data point is the median value of the data points remaining in the ad hoc grouping after discarding the outlier data point. In yet another approach, the healing data point may be calculated by taking all the data points in the ad hoc grouping other than the largest and the smallest data points, summing the remaining data points, and dividing the sum by the total number of data points used in the calculation. The total number of data points may be the total number of data points minus three (e.g., the largest data point, the smallest data point, and the outlier data point). The total number of data points may be the total number of data points minus two (e.g., the largest data point and the smallest data point). The total number of data points may be the total number of data points minus one (e.g., the outlier data point).

In various embodiments of method 500 and/or method 600, updated conditions associated with the objects may be received in any manner known in the art. The ad hoc groupings for the objects may be adjusted based on at least one of the updated conditions. For example, a location grouping for objects located on a truck may be adjusted (e.g., split) into a location grouping for objects sent to a juicing processing location and a location grouping for objects sent to a cooling processing location.

In some approaches, in response to receiving updated conditions, the various methods may include redetermining whether any data points are outliers in the adjusted ad hoc groupings and discarding any outlier data points. The outlier data points may be replaced with replacement points based on data point(s) associated with the objects in the adjusted ad hoc grouping according to any of the approaches described above.

In preferred approaches, the conditions for creating ad hoc groupings do not have to be the same condition for terminating the groupings. In one approach, in response to receiving updated conditions for the objects, an ad hoc grouping may be terminated wherein the updated condition is different from the condition for creating the ad hoc grouping. For example, an ad hoc grouping may be created based on location. The location ad hoc grouping may be terminated in response to updated conditions corresponding to temperatures for various processing steps.

In preferred embodiments, ad hoc groupings based on proximity may be temporary. For example, proximity may last for an undetermined amount of time. In some approaches, proximity ad hoc groupings may be defined by a start of one event (condition) to the end of a second event. For instance, a pallet may enter a new grouping when it is loaded onto a trailer, and may remain as part of that grouping until it is unloaded from the trailer. These two events may be determined in separate locations at any time. For example, if there are eight pallets coming in from the field but one of the sensors is not reading, the data validation may assume from the other seven readings that the eighth pallet was substantially the same. A substitute entry for the eighth pallet may be entered. The ad hoc grouping allows validation and then healing of the data if necessary. The data may be healed either with the average read, an actual reading associated with the ad hoc grouping, etc. The harvesters may push a button every time they build a pallet of food which causes inclusion of a timestamp into the data for process feedback. Additional healing may be done if harvesters do not press the button, or press all of the buttons at the same time. In these cases, the grouping may be based on the standard average value. A certain grouping in a certain process step may have an expected sequence of values or relationship of data; for instance, a pallet may be built every 5 minutes, such that the pallets on a truck should reflect a sequence of 5 minute intervals.

Groupings may be determined by all devices experiencing a specific condition or event at the same or similar time, and then the ungrouping (e.g., terminating a grouping, adjusting a grouping, etc.) may be determined by any other subsequent trigger and/or updated conditions. In some approaches, groupings may be defined by start and stop times. In another approach, the ad hoc groupings may be created by the start and stop times in combination with the location. Conditions, time, and location may all define the groupings. The start and stop time do not have to be determined by the same condition. For example, an ad hoc grouping may be created in response to objects being in the same location at the same time and the ad hoc grouping may end upon reaching the same temperature and/or humidity. Another example may be a grouping of produce pallets that enters a pre-cool process and may exit the pre-cool process at a temperature reading of 34° F. As each pallet device detects the 34° F. temperature, the pallets become part of the pre-cool exit group. The pallet devices remain in the grouping until the pallets enter cold storage, which may be a separate waypoint and/or condition. The temperature, which was the starting trigger (condition), is no longer the subsequent trigger for ending the group. Within this group, if the temperature of one of the sensors is not changing, there may be a reading through the validation that the sensor is broken and/or fell off. An alert may be sent and/or the data may be healed to correspond to the other temperature readings.

Ad hoc groupings may be created by the conditions of movement and/or lack of movement detected by the sensors. Lack of movement may imply that something is in storage and no readings may be taken in order to save power. Once vibrations or changes in direction are detected (e.g., via accelerometers) the sensors may start taking readings again.

Devices may be members of multiple groupings for multiple reasons. For example, a processor may want to maintain an initial grouping that came in for processing but may want to create a separate grouping for pre-processing and prioritization. These subgroupings may be formed for different processing steps. For example, one shipment of strawberries may be divided into subgroupings for shelf-ready product, juicing, jams, etc. All the subgroupings may be under the larger harvest data grouping in addition to smaller prioritized groupings for processing. The information from both groupings may travel with the product (object) from facility to facility.

Ad hoc groupings may include mixed objects in at least some embodiments. For example, a trailer may be loaded with half strawberries and half blueberries. The subgroupings may be further used to differentiate between the groupings based on condition. Products on the same truck may be part of the same grouping based on a location related condition. The groupings may also be product related. The pallets of food may have one grouping for their location in the trailer, but separate groupings associated with different harvesting information for pallets of strawberries and pallets of blueberries. Further, the groupings may be differentiated by pallets where temperature conditions are important and pallets where temperature conditions are irrelevant. An example includes a truck carrying pallets of avocados and pallets of pistachios. The pallets of avocados may require a certain temperature condition while pistachios have no relevant temperature condition.

The ad hoc groupings as disclosed herein may be especially important for validation of valuable shipments. Valuable shipments are often hijacked, and the contents of the shipment are taken out and replaced. The replaced shipment and resold products create a gray market for selling the actual original products. This gray market is prevalent in certain parts of the world where lower quality food is often substituted into the shipment and sold for full value. The higher quality food may be additionally sold on the gray market under a different packaging.

Another example of a system where validation (e.g., food validation) may be useful involves validation of meat. A known instance of food substitution involved a beef shipment from the U.K. to France. While beef was properly packaged and shipped from its origin, the product was intercepted during transit and horse meat was substituted into the initial packaging. The company supplying the meat was not responsible, but the lack of information gathered during shipping made detection of the point of interception and details thereof difficult to determine.

Food validation using sensors may document the groupings of pallets of food shipped associated with particular packaging and may alert to any changes in the shipment. The tracking of shipments may be done automatically. A substitution problem may be discovered instantaneously instead of after months of investigation. The food validation and sensors may be used to validate the source and prevent substitutions within the supply chain by maintaining the originally created groupings.

In one approach, food validation may be used for the international importation of seafood. For example, an importer may often call seafood red snapper, when it is not, in order to request a higher value for lower quality fish. The substitution itself may not be unhealthy to the consumer but food validation may ensure that the consumer is getting the product that they believed they were paying for.

Various data validation and/or data healing techniques disclosed herein may be applied to pharmaceuticals, electronics, or anything that may conceivably be shipped and substituted for lower quality goods. An example for non-food validation includes lithograph production. Lithographs may be high-end paintings made in limited quantities. These lithographs may be validated at auctions but may be otherwise substituted for unauthorized copies. The addition of sensors and grouping validation may add significant value to the original grouping of lithographs.

The system that collects the device data may track the frequency, type and number of missing data elements or invalidate data elements to further determine if there is a pattern of incorrect data. The pattern may correlate to the device, the process, the location, a user interaction or some combination of these and other conditions recorded. This pattern of information may help determine if the device is non-functioning, if the device communication is out, if the device misplaced, etc. This pattern of information may be equivalent to a fingerprint of the missing data. This pattern may be helpful to determine what type of event is occurring. The data that is not present may lead to the discovery of important information.

The data may be further graded to determine the validity of the data. Data from bar code reads are very susceptible to issues caused by misreading and/or application of new sticker bar codes. Sensors are more reliable because their IDs are embedded in silicon and may also be based on location. Sensors receive higher validity grades based on their relative difficulty to hack compared to bar codes. The ad hoc grouping additionally increases the validity integrity. The validity integrity may be altered based on whether certain parameters are met and whether the grade was within the average of the sequence and whether the data relationship is what was expected.

For example, a pallet of strawberries may typically take ten minutes to build. If the data is outside of predefined parameters, between eight and twelve minutes for example, the validity of the data may be checked to see what caused the difference. The whole sequence may be over the parameter. In this example, the whole sequence may be over fifteen minutes because of a smaller crew of harvesters. Alternatively, there may be one less pallet reported and an alert may be sent.

One way to validate the data is using cellular tags or GPS to validate the location. Bluetooth tags, RFID tags, active tags, different wireless local technology, Wi-Fi, may be validated by the location of the access point on which the data is read. There are multiple ways to evaluate the location conditions of the tags or what tags are associated with. The location condition may be evaluated by the sensor reading itself or by the metadata on top of the sensor reading. The metadata itself may become a valid condition. For example, the reading may output the weather at harvest condition if the weather is added to the timestamp. Metadata may help further refine the data from the device. The metadata may change the grouping. The metadata may, depending on the access point, determine the location based on that access point.

Data validation may also be used for calibration. Calibration of readings may be important for determining proportions within the product. This may be especially important for fulfilling the Food and Drug Administration (FDA) requirements in determining the efficacy of a pharmaceutical or maintaining safe temperatures for food. Data validation may help automate the calibration process and increase efficiency.

Data validation may also add visibility to the processing steps. Different owners may be responsible for different processing steps. It may be helpful to validate the process steps for the subsequent owners in the process. In the example of food processing, one owner may own the field, another owner may own the brand, and another owner may own the processing plant and equipment. Each owner may be able to see the separately owned processing steps remotely.

Data validation reduces “nuisance alerts.” For example, when a larger grouping of products is on a truck with strawberries and pistachios, there is one overall condition based on the location and each grouping may have a different temperature condition. The data validation of the delivery may report one grouping based on the location on the truck and separate temperatures for the subgroupings. The data validation prevents sending nuisance alert for an increase in temperature for the pistachios and sends a valid alert for an increase in temperature in the strawberries even though the products are in the same location grouping on the truck.

Data validation may help to keep the trailers of product full by maximizing the packing through grouping in a fluid manner. Processors want full trailers in order to save time, money, fuel, etc. Consolidation centers, assisted by the data provided by the sensors, may grouping like-conditioned pallets together based on the temperatures or other conditions that lead to grouping.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that may be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A computer-implemented method, comprising:
receiving one or more monitored conditions associated with objects;
creating ad hoc groupings for the objects, wherein each ad hoc grouping is based on at least one of the conditions;
receiving at least one data point associated with each object;
selecting an ad hoc grouping for validation; and
determining whether the data points are valid using the data points associated with the objects in the selected ad hoc grouping.

2. The method of claim 1, comprising:
receiving updated conditions associated with the objects; and
adjusting the ad hoc groupings for the objects based on at least one of the updated conditions.

3. The method of claim 2, comprising:
terminating one or more of the ad hoc groupings based on at least one of the updated conditions.

4. The method of claim 2, wherein the at least one of the updated conditions is different from the at least one of the conditions for creating the ad hoc grouping.

5. The method of claim 1, wherein each object belongs to one or more ad hoc grouping.

6. The method of claim 1, wherein determining whether the data points are valid includes determining whether the data points are valid for a first function; and
in response to determining that the data points are invalid for a first function, maintaining the data points for a second function.

7. The method of claim 1, wherein the objects are perishable food products.

8. A computer-implemented method, comprising:
determining ad hoc groupings for objects, wherein each ad hoc grouping is based on at least one condition of the objects;
receiving data points associated with the objects;
determining whether one or more of the data points associated with the objects in one of the ad hoc groupings is an outlier from other data points associated with the objects in the ad hoc grouping;
in response to determining that one or more of the data points is an outlier, discarding the one or more outlier data points; and
replacing the one or more outlier data points with a replacement data point determined based on the other data points associated with the objects in the ad hoc grouping.

9. The method of claim 8, comprising:
receiving updated conditions associated with the objects; and
adjusting the ad hoc groupings for the objects based on at least one of the updated conditions.

10. The method of claim 9, comprising, in response to adjusting the ad hoc groupings, redetermining whether one or more data points is an outlier;
in response to determining that the one or more data points is an outlier, discarding the one or more data points; and
replacing the one or more data points with a replacement data point determined based on the other data points associated with the objects in the adjusted ad hoc grouping.

11. The method of claim 9, wherein the at least one of the updated conditions is different from the at least one of the conditions for creating the ad hoc grouping.

12. The method of claim 8, wherein each object belongs to one or more ad hoc grouping.

13. The method of claim 8, wherein the replacement data point is calculated based on an average of the data points associated with the objects in the ad hoc grouping.

14. The method in claim 13, wherein the replacement data point includes a predetermined offset to reflect a more conservative interpretation of the data.

15. The method of claim 8, wherein the replacement data point is one of the data points associated with the objects in the ad hoc grouping.

16. The method of claim 15, wherein the replacement data point includes a predetermined offset to reflect a more conservative interpretation of the data.

17. The method of claim 8, wherein the outlier data point is one of a sequence of data points associated with the object in the ad hoc grouping.

18. The method in claim 17, wherein the replacement data point includes a predetermined offset to reflect a more conservative interpretation of the data.

19. The method of claim 8, wherein the objects are perishable food products.

20. A computer program comprising a nontransitory computer readable storage medium having program instructions embodied therewith, the program instructions executable by a computer to cause the computer to perform a method comprising:
determine, by the computer, ad hoc groupings for objects, wherein each ad hoc grouping is based on at least one of condition of the objects;
receive, by the computer, data points associated with the objects;
determine, by the computer, whether one or more of the data points associated with the objects in one of the ad hoc groupings is an outlier from other data points associated with the objects in the ad hoc grouping;
in response to determining that one or more of the data points is an outlier, discard, by the computer, the one or more outlier data points; and
replace, by the computer, the one or more outlier data points with a calculated replacement data point determined based on the other data points associated with the objects in the ad hoc grouping.
